(19) United States
(12) Patent Application Publication
(10) Pub. No.: US 2021/0162555 A1
(43) Pub. Date: Jun. 3, 2021

(54) SUPPORT STRUCTURE

(71) Applicant: FANUC CORPORATION, Minamitsuru-gun (JP)

(72) Inventor: Masahiro MUROTA, Minamitsuru-gun (JP)

(21) Appl. No.: 17/102,057

(22) Filed: Nov. 23, 2020

(30) Foreign Application Priority Data
Nov. 29, 2019 (JP) 2019-216603

(51) Int. Cl. B23Q 11/08

(52) U.S. Cl. CPC B23Q 11/0816

(57) ABSTRACT

A support structure includes: at least two shafts extending in a first direction in which the cover expands and contracts, and arranged inside the cover so as to be spaced from each other in a second direction that intersects the first direction; a bush provided on each of the at least two shafts so as to be slidable along the shafts; and a cover support member. The cover support member includes a main part supporting the cover, a first connection part connecting the main part and the bush so as not to change the relative position between the bush and the main part, and a second connection part connecting the main part and the bush in a manner that the relative position between the bush and the main part can be changed.

### CROSS-REFERENCE TO RELATED APPLICATION

This application is based upon and claims the benefit of priority from Japanese Patent Application No. 2019-216603 filed on Nov. 29, 2019, the contents of which are incorporated herein by reference.

### BACKGROUND OF THE INVENTION

### Field of the Invention:

The present invention relates to a support structure that supports an expandable cover.

### Description of the Related Art

Japanese Laid-Open Patent Publication No. 2018-039061 discloses a support structure of a cover (bellows) that can expand and contract in the moving direction of a slide table. This support structure includes a pair of shafts arranged substantially parallel to the moving direction of the slide table, a pair of bushes provided slidably on the respective shafts, and a cover supporting member which is attached to the pair of bushes and supports a cover.

### SUMMARY OF THE INVENTION

In the support structure of Japanese Laid-Open Patent Publication No. 2018-039061, in some cases, the pair of shafts are not installed in parallel. In this case, since one of the paired shafts is skewed or inclined with respect to the other, the distance between the shafts becomes uneven, so that the movable range (slidable range) of the bushes on the shafts is reduced.

It is therefore an object of the present invention to provide a support structure capable of suppressing the reduction of the movable range of the bushes even when the shafts are not installed in parallel.

An aspect of the present invention resides in a support structure for supporting an expandable cover, the support structure including: at least two shafts extending in a first direction in which the cover expands and contracts, and arranged inside the cover so as to be spaced from each other in a second direction that intersects the first direction; a bush provided on each of the at least two shafts and configured to be slidable along the shaft; and a cover support member, which includes a main part configured to support the cover, a first connection part configured to connect the main part and the bush so as not to change the relative position between the bush and the main part, and a second connection part configured to connect the main part and the bush in such a manner that the relative position between the bush and the main part can be changed.

According to the present invention, it is possible to suppress the reduction of the movable range of the bushes even in a case where the shafts are not installed in parallel.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic view of a slide table device of an embodiment;

FIG. 2 is a schematic view of a state in which a part of the cover of FIG. 1 is cut out;

FIG. 3 is a schematic view of a state in which the table and a part of the covers of FIG. 1 is removed;

FIG. 4 is a schematic sectional view showing a guide rail and slide in FIG. 3;

FIG. 5 is a schematic sectional view showing shafts, bushes and a cover support member in FIG. 3;

FIG. 6 is a schematic view when viewed from the direction of the arrow in FIG. 5;

FIG. 7 is a schematic sectional view showing a state when the distance between the shafts is increased;

FIG. 8 is a schematic sectional view showing a state when the distance between the shafts is reduced;

FIG. 9 is a schematic view showing a cover support member of a modification 1 from the same viewpoint as that of FIG. 6;

FIG. 10 is a schematic view showing a cover support member of a modification 2 from the same viewpoint as that of FIG. 6;

FIG. 11 is a schematic view showing a cover support member of a modification 3 from the same viewpoint as that of FIG. 6; and

FIG. 12 is a schematic sectional view of shafts, bushes, and a cover support member of a modification 4.

### DESCRIPTION OF THE PREFERRED EMBODIMENTS

A preferred embodiment of the present invention will be described below in detail with reference to the accompanying drawings.

### Embodiment

### [Structure of Slide Table Device]

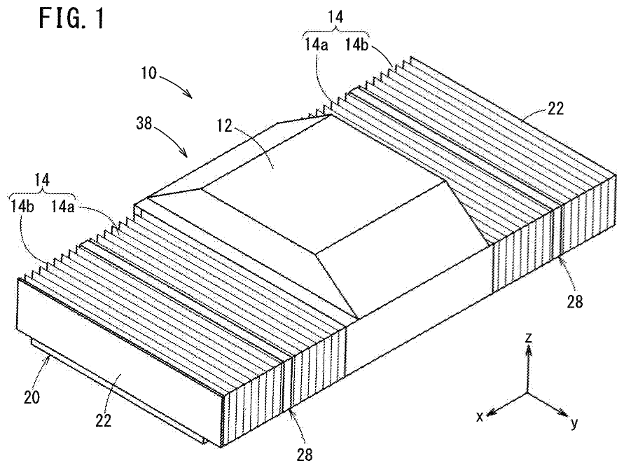

FIG. 1 is a schematic view of a slide table device 10. The slide table device 10 is used for a machine tool that processes (machines) a workpiece with a tool, a measuring machine having a moving mechanism, or the like. The slide table device 10 has a movable table 12 along a first direction (x-axis direction) in which the x-axis of FIG. 1 extends. Expandable covers 14 are provided respectively on both sides of the table 12 in the moving direction (i.e., on the x-axis positive direction side and the x-axis negative direction side).

The cover 14 is formed so as to have a bellows-shape and serves to prevent liquid, such as a coolant ejected to a processed portion, or foreign material such as cutting chips generated during machining, from entering the interior. The covers 14 are provided respectively on the x-axis positive direction side and the x-axis negative direction side with the table 12 interposed therebetween. The cover 14 on the x-axis positive direction side and the cover 14 on the x-axis negative direction side expand and contract along the first direction (x-axis direction) in conjunction with the movement of the table 12. When the table 12 moves in the x-axis positive direction, the cover 14 on the x-axis positive direction side contracts along the first direction (x-axis direction) while the cover 14 on the x-axis negative direction side expands in the first direction (x-axis direction). When the table 12 moves to the negative direction side of the x-axis, the cover 14 on the x-axis negative direction side contracts along the first direction (x-axis direction) while the cover 14 on the x-axis positive direction side expands in the first direction (x-axis direction)

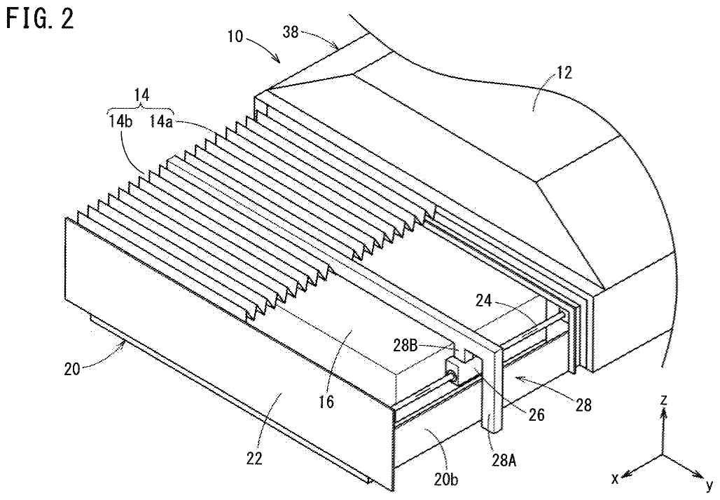

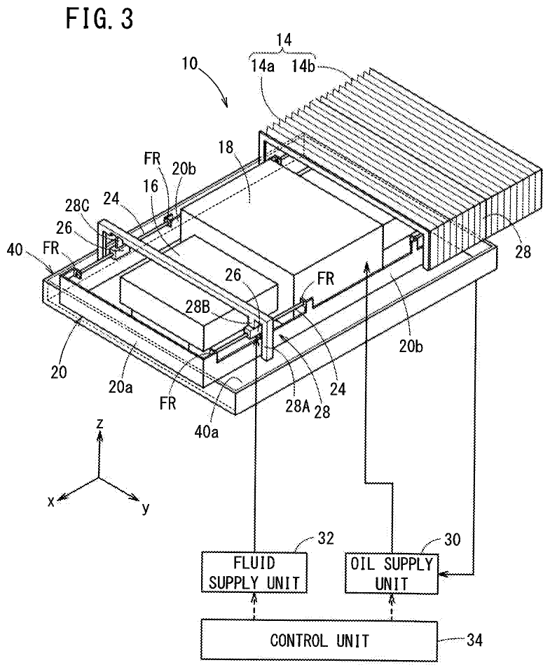

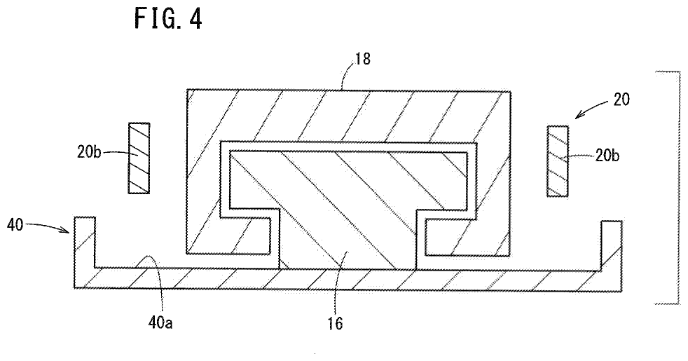

FIG. 2 is a schematic view of a state in which a part of the cover 14 of FIG. 1 is cut out, FIG. 3 is a schematic view of a state in which the table 12 and a part of the covers 14 of FIG. 1 is removed, and FIG. 4 is a schematic sectional view of a guide rail 16 and a slide 18 in FIG. 3.

The slide table device 10 includes a guide rail 16, a slide 18, and an oil pan 40. The oil pan 40 is formed in a box shape with its top open. The guide rail 16 is fixed to a bottom 40a of the oil pan 40 (see FIGS. 3 and 4). The guide rail 16 is formed so as to extend in the first direction (x-axis direction). When the guide rail 16 is viewed from the first direction (x-axis direction), the cross section of the guide rail 16 is formed in a substantially T shape (see FIG. 4). The slide 18 is provided over the guide rail 16. When the slide 18 is viewed from the first direction (x-axis direction), the slide 18 is arranged so as to straddle the upper part of the guide rail 16 (see FIG. 4). The slide 18 is driven by an unillustrated driving device along the guide rail 16 in the x-axis positive direction and the x-axis negative direction. The table 12 is supported by the slide 18. The table 12 moves integrally with the slide 18 in the x-axis positive direction side and the x-axis negative direction side. The table 12 and the slide 18 constitute a slide table 38.

The slide table device 10 has a support frame 20 that encloses the outsides of the guide rail 16 and the slide 18 around the entire circumference (see FIG. 3). The support frame 20 is formed as a rectangular frame shape that opens upward and downward. The support frame 20 is arranged above the oil pan 40 (see FIG. 4) and is fixed to the oil pan 40 through unillustrated fixation members. The support frame 20 has a pair of side walls 20a opposing each other in the longitudinal direction of the support frame 20 and a pair of side walls 20b opposing each other in the lateral direction of the support frame 20.

The x-axis positive direction side cover 14 and the x-axis negative direction side cover 14 are provided so as to straddle the outer sides of the side wall 20b of the support frame 20 (see FIG. 1). An end of the x-axis positive direction side cover 14 that lies on the table 12 side is attached to the table 12 while the other end of the cover 14 that faces away from the table 12 is attached to a fixing plate 22 fixed to the outer surface of the side wall 20a of the support frame 20 (see FIG. 2). An end of the x-axis negative direction side cover 14 that lies on the table 12 side is attached to the table 12 while the other end of the cover 14 that faces away from the table 12 is attached to another fixing plate 22 fixed to the outer surface of the side wall 20a of the support frame 20 (see FIG. 1). Thus, the exteriors of the side walls 20a and the side walls 20b of the support frame 20 and the upper opening of the support frame 20 are covered with the table 12, the covers 14, and the fixing plates 22.

### [Slide Support Structure]

A gap is formed between the guide rail 16 and the slide 18 (see FIG. 4). Hydraulic oil is supplied into the gap by an oil supply unit 30 (see FIG. 3). The oil supply unit 30 is controlled by a control unit 34, and supplies hydraulic oil into the gap between the guide rail 16 and the slide 18 at a constant pressure. This creates an oil bearing between the guide rail 16 and the slide 18, so that the slide 18 is held in a floating state with respect to the guide rail 16.

Since the guide rail 16 and the slide 18 do not directly contact each other, friction between the guide rail 16 and the slide 18 is only due to viscous resistance of the hydraulic oil. Therefore, the friction between the guide rail 16 and the slide 18 is greatly reduced as compared with the friction between the guide rail 16 and the slide 18 when rollers or the like are provided between the guide rail 16 and the slide 18. The oil supply unit 30 includes a strainer for filtering the hydraulic oil, a pump for sending the hydraulic oil, and the like. The oil supply unit 30 draws in the hydraulic oil stored in the oil pan 40, and supplies the hydraulic oil to the gap between the guide rail 16 and the slide 18. The hydraulic oil that has flowed out from the gap between the guide rail 16 and the slide 18 is recirculated back to the oil pan 40 and is stored therein.

### [Cover Support Structure]

The support structure of the x-axis positive direction side cover 14 and the support structure of the x-axis negative direction side cover 14 are the same, and only the support structure of the x-axis positive direction side cover 14 will thus be described.

Two shafts 24 are attached to the support frame 20. The support frame 20 is a shaft support member that supports the shafts 24. In the support frame 20, each of the side walls 20b that face each other in the lateral direction of the support frame 20 has a pair of flanges FR protruding inward from the corresponding side wall 20b. The paired flanges FR face each other in the first direction (x-axis direction) along which the cover 14 expands and contracts. The shaft 24 is arranged between the paired flanges FR on each side wall 20b of the support frame 20, and is fixed to the flanges FR so that the two shafts 24 are attached to the support frame 20. The two shafts 24 are spaced from each other in a second direction that intersects the first direction in which the cover 14 expands and contracts, and the shafts 24 extend in the first direction. In the present embodiment, the second direction is the y-axis direction that is perpendicular to the first direction (x-axis direction) in the horizontal plane.

Each of the two shafts 24 is provided with a bush (bushing) 26 that can slide on the shaft 24. Each bush 26 is attached to a cover support member 28 for supporting the cover 14. The cover support member 28 moves along the shafts 24 together with the bushes 26.

A fluid such as air is supplied between the bush 26 and the shaft 24 by a fluid supply unit 32. The fluid supply unit 32 is controlled by the control unit 34 so as to supply a fluid between the bush 26 and the shaft 24 at a predetermined pressure. This creates a fluid bearing between the bush 26 and the shaft 24, so that the bush 26 is held in a floating state with respect to the shaft 24. Since the bush 26 and the shaft 24 do not come into direct contact with each other, the friction between the bush 26 and the shaft 24 is only due to the viscous resistance of the fluid. Therefore, the friction between the bush 26 and the shaft 24 is greatly reduced as compared with the friction between the bush 26 and the shaft 24 when the bush 26 and the shaft 24 are in contact with each other. The fluid supply unit 32 includes a filter for removing dust and the like from the sucked air, a pump for sending the fluid, and the like.

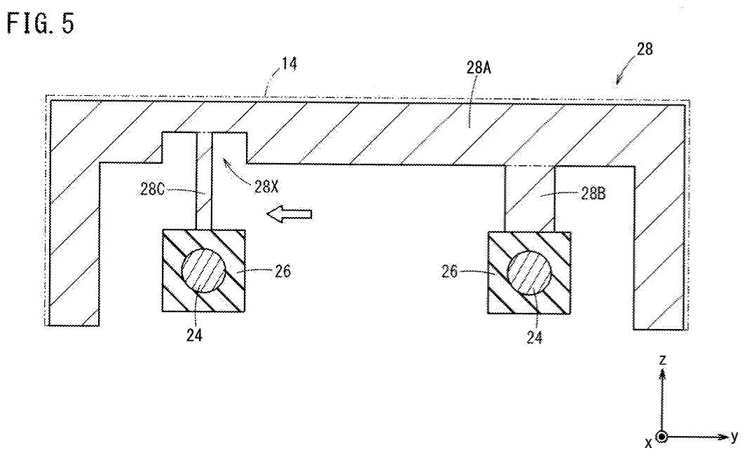

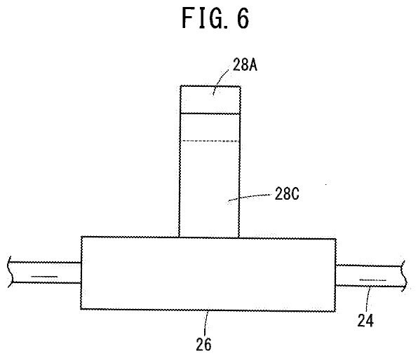

The above cover support member 28 will be described in more detail. FIG. 5 is a schematic sectional view of the shafts 24, the bushes 26 and the cover support member 28 in FIG. 3, and FIG. 6 is a schematic view when viewed from the direction of the arrow of FIG. 5. The cover support member 28 has a main part 28A, a first connection part 28B, and a second connection part 28C.

The main part 28A is a main body portion that supports the cover 14. The main part 28A is attached to the cover 14 with a portion of the main part being exposed to the outside of the cover 14 (see FIGS. 1 and 2). The cover 14 is divided into a first cover portion 14a located on the side closer to the table 12 and a second cover portion 14b located on the side farther from the table 12 while the aforementioned portion of the main part 28A is located between the first cover portion 14a and the second cover portion 14b. By fixing each of the first cover portion 14a and the second cover portion 14b to the main part 28A that is arranged between the first cover portion 14a and the second cover portion 14b, the main part 28A is attached to the cover 14. Here, the shape of the main part 28A is not particularly limited. In the present embodiment, the main part 28A is formed in the shape of a character “Π” along the outer shape of the cover 14, and has a rectangular cross section (see FIGS. 3 and 5).

The first connection part 28B is a leg that supports the main part 28A. The first connection part 28B connects the main part 28A and the bush 26 in such a manner that the relative position of the bush 26 with respect to the main part 28A will not change. The bush 26 that is connected to the main part 28A through the first connection part 28B is one of the bushes 26 arranged on the two shafts 24.

The second connection part 28C is a leg that supports the main part 28A. The second connection part 28C connects the main part 28A and the bush 26 in such a manner that the relative position of the bush 26 with respect to the main part 28A can change. The bush 26 that is connected to the main part 28A through the second connection part 28C is the other of the bushes 26 arranged on the two shafts 24.

The second connection part 28C is less in rigidity and thickness than the first connection part 28B. In the embodiment, the second connection part 28C is a flat spring (plate spring) that can be deformed in the second direction. That is, the second connection part 28C can be deformed in the directions approaching and separating away from the adjacent shaft 24.

The main part 28A has, formed therein, a recess portion 28X into which an end portion of the second connection part 28C enters. The end portion is not in contact with the wall surface of the recess portion 28X. This configuration increases a length of the second connection part 28C extending from the bush 26 to the main part 28A, compared with a case where the recess portion 28X is not formed, and hence can increase the amount of deformation of the second connection part 28C.

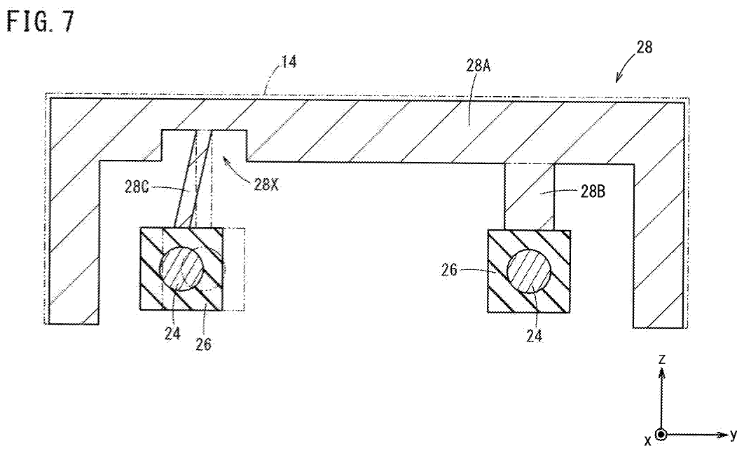

When one of the shafts 24 is skewed or inclined with respect to the other, the distance between the two shafts 24 varies. As shown in FIG. 7, when the distance between the shafts 24 is larger than in the case where the two shafts 24 are arranged in parallel (two-dot chain line), the second connection part 28C deforms so as to be away from the adjacent shaft 24. Therefore, even if the distance between the shafts 24 increases, hindrance to the sliding operation of the bushes 26 can be alleviated.

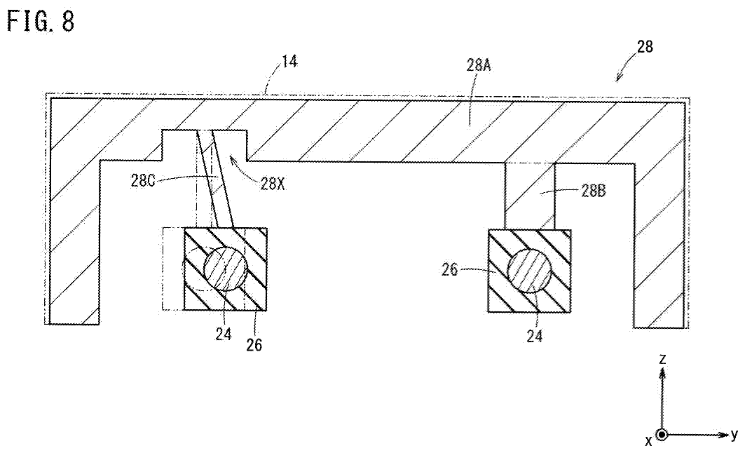

On the other hand, as shown in FIG. 8, when the distance between the shafts 24 is smaller than in the case where the two shafts 24 are arranged in parallel (two-dot chain line), the second connection part 28C deforms so as to come closer to the adjacent shaft 24. Therefore, even if the distance between the shafts 24 decreases, hindrance to the sliding operation of the bushes 26 can be alleviated.

Thus, in the present embodiment, the relative position of the bush 26 provided on one of the two shafts 24 is not displaced with respect to the main part 28A, while the relative position of the bush 26 provided on the other of the two shafts 24 can be changed with respect to the main part 28A. As a result, even if one of the two shafts 24 is slanted to the other, the reduction of the movable range of the bushes 26 can be suppressed.

### MODIFICATION

The above embodiment may be modified as follows.

### Modification 1

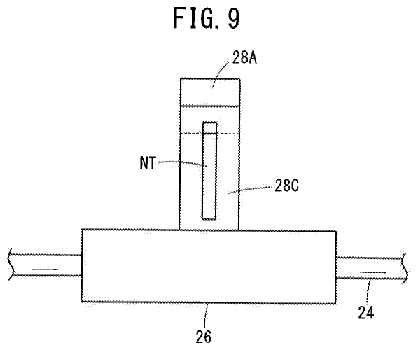

FIG. 9 is a schematic view showing a cover support member 28 of a modification 1, viewed from the same viewpoint as that of FIG. 6. In FIG. 9, the same reference numerals are allotted to the components equivalent to those described in the above embodiment. In this modification, the description overlapping with the above embodiment will be omitted.

In this modification, the second connection part 28C is a flat spring (plate spring) that can be deformed in the second direction (y-axis direction) as in the above embodiment. The flat spring has one cutout portion NT formed by cutting away a portion of the spring along a third direction extending from the bush 26 toward the main part 28A. This enables the second connection part 28C to easily rotate and twist about the third direction, so that the degree of freedom of deformation of the second connection part 28C is increased.

The third direction is preferably the z-axis direction orthogonal to both the first direction (x-axis direction) and the second direction (y-axis direction). Further, multiple cutout portions NT may be formed. When the flat spring has multiple cutout portions NT, the multiple cutout portions NT may be arranged in a row, one or more of the cutout portions NT may be arranged in each of multiple rows, or multiple cutout portions NT may be arranged in an irregular manner.

### Modification 2

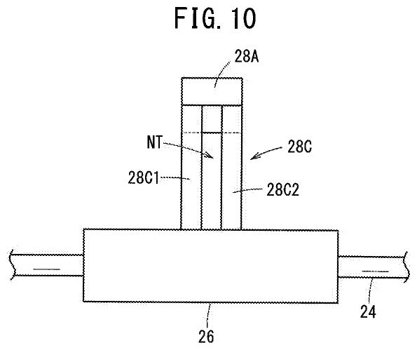

FIG. 10 is a schematic view showing a cover support member 28 of a modification 2, viewed from the same viewpoint as that of FIG. 6. In FIG. 10, the same reference numerals are allotted to the components equivalent to those described in the above embodiment. In this modification, the description overlapping with the above embodiment will be omitted.

In this modification, the second connection part 28C is divided by a cutout portion NT into two portions, i.e., forming rod-shaped first and second divided portions 28C1 and 28C2 which each have a rectangular cross section. The first divided portion 28C1 and the second divided portion 28C2 may have the same shape or different shapes from each other.

As described above, in this modification, since the second connection part 28C is divided into the first divided portion 28C1 and the second divided portion 28C2 by the cutout portion NT, it becomes possible to facilitate twisting of the second connection part 28C about an axis parallel to the third direction, as in the above modification 1. Therefore, it is possible to increase the degree of freedom of deformation of the second connection part 28C.

Here, three or more divided portions may be formed in the second connection part 28C. When the second connection part 28C includes three or more divided portions, the multiple divided portions may be arranged in a row, one or two or more divided portions may be are arranged in each of multiple portions, or multiple divided portions may be arranged in an irregular manner.

### Modification 3

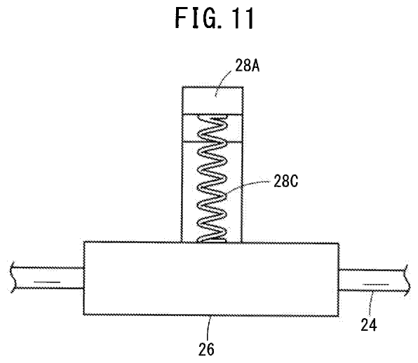

FIG. 11 is a schematic view showing a cover support member 28 of a modification 3, viewed from the same viewpoint as that of FIG. 6. In FIG. 11, the same reference numerals are allotted to the components equivalent to those described in the above embodiment. In this modification, the description overlapping with the above embodiment will be omitted.

In this modification, the second connection part 28C is a coil spring that helically extends from the bush 26 toward the main part 28A along the third direction. Provision of the second connection part 28C as a coil spring facilitates twisting of the second connection part 28C about the axis extending in the third direction, as in the above modifications 1 and 2, thus making it possible to increase the degree of freedom of deformation of the second connection part 28C.

Here, the second connection part 28C may be a rod-shaped spring having a polygonal cross section such as a rectangular cross section, or a rod-shaped spring having a circular cross section including an elliptical cross section, instead of the coil spring.

### Modification 4

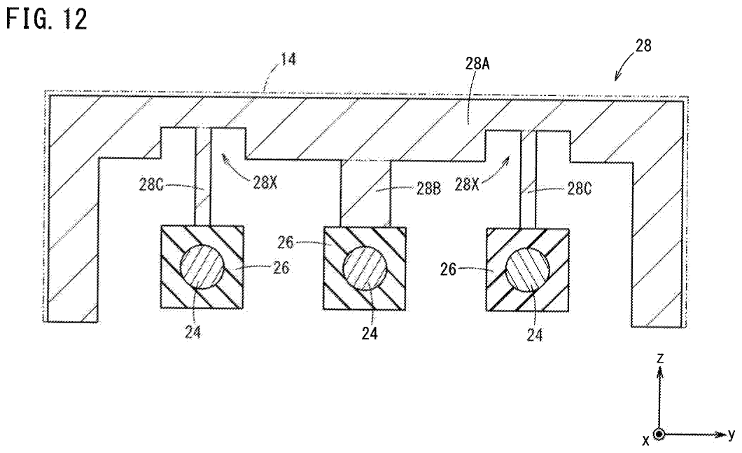

FIG. 12 is a schematic sectional view showing shafts 24, bushes 26 and a cover support member 28 of a modification 4. In FIG. 12, the same reference numerals are allotted to the components equivalent to those described in the above-described embodiment. In this modification, the description overlapping with the above embodiment will be omitted.

In this modification, three shafts 24 extending in the first direction in which the cover 14 expands and contracts are provided in the support frame 20 (see FIG. 3) and spaced at intervals from each other. Of the three shafts 24, the shafts 24 at both sides are fixed to respective side walls 20b of the support frame 20 in the same manner as in the above embodiment. Of the three shafts 24, the middle shaft 24 is fixed, for example, to the pair of side walls 20a of the support frame 20.

The bush 26 provided on each of the shafts 24 at both sides is connected to the main part 28A by the second connection part 28C, while the bush 26 provided on the middle shaft 24 is connected to the main part 28A by the first connection part 28B.

According to this modification, even if at least one of the shafts 24 at both sides is inclined with respect to the middle shaft 24, it is possible to alleviate the hindrance to the sliding operation of the bushes 26 as in the above embodiment. As a result, the reduction of the movable range of the bushes 26 can be suppressed. Here, four or more shafts 24 may be provided.

### Modification 5

In the above embodiment, the recess portion 28X is formed in the main part 28A. However, instead of, or in addition to, the above embodiment, the bush 26 may include, formed therein, a recess portion 28X.

### Modification 6

In the above embodiment, a fluid bearing is created between the bush 26 and the shaft 24. However, instead of the above embodiment, a rolling bearing or a sliding bearing may be provided between the bush 26 and the shaft 24.

### Modification 7

In the above embodiment, the main part 28A is attached to the cover 14 with a portion of the main part being exposed to the outside of the cover 14. However, instead of the above embodiment, the main part 28A may be attached to the cover 14 in a state where the entire main part 28A is located inside the cover 14. In the case of this modification, the cover 14 is not separated into the first cover portion 14a and the second cover portion 14b. The main part 28A is attached to the cover 14 by fixing a portion of the main part 28A located inside the cover 14 to the inner surface of the cover 14.

### Modification 8

The above embodiment and the above modifications may be arbitrarily combined as long as no technical inconsistency occurs.

### INVENTION

The aspects of the invention that can be obtained from the above embodiment and modifications will be described as follows.

The present invention is a support structure for supporting an expandable cover (14). The support structure includes: at least two shafts (24) extending in a first direction in which the cover (14) expands and contracts, and arranged inside the cover (14) so as to be spaced from each other in a second direction that intersects the first direction; a bush (26), provided on each of the at least two shafts (24) and configured to be slidable along the shaft; and a cover support member (28). The cover support member (28) includes a main part (28A) configured to support the cover (14), a first connection part (28B) configured to connect the main part (28A) and the bush (26) so as not to change the relative position between the bush (26) and the main part (28A), and a second connection part (28C) configured to connect the main part (28A) and the bush (26) in such a manner that the relative position between the bush (26) and the main part (28A) can be changed.

With the above configuration, even if the shafts (24) are not installed in parallel with each other and the distance between the two shafts (24) is accordingly uneven, i.e., not constant, displacement of the position of the bush (26) relative to the main part (28A) can keep the distance substantially even, thanks to the second connection part (28C). Thus, even when the shafts (24) are not installed in parallel, it is possible to suppress the reduction of the movable range of the bushes (26).

The second connection part (28C) may be configured to be deformable at least in the second direction. This makes it possible to keep the distance between the two shafts (24) substantially even thanks to deformation of the second connection part (28C).

The second connection part (28C) may be a flat spring, and the flat spring may have a cutout portion (NT) formed by cutting away a portion of the flat spring along a third direction extending from the bush (26) to the main part (28A). This configuration facilitates twisting of the second connection part (28C) about the axis extending in the third direction, and hence increases the degree of freedom of deformation of the second connection part (28C).

At least one of the main part (28A) and the bush (26) may include, formed therein, a recess portion (28X) which an end of a spring element of the second connection part (28C) enters, and the end may be not in contact with the wall surface of the recess portion (28X). This configuration makes it possible to increase the length, of the second connection part (28C), from the bush (26) to the main part (28A), compared to the case when no recess portion (28X) is formed. As a result, the amount of deformation of the second connection part (28C) can be increased.

The present invention is not particularly limited to the embodiment described above, and various modifications are possible without departing from the essence and gist of the present invention.

What is claimed is:

1. A support structure for supporting an expandable cover, comprising:
at least two shafts extending in a first direction in which the cover expands and contracts, and arranged inside the cover so as to be spaced from each other in a second direction that intersects the first direction;
a bush provided on each of the at least two shafts and configured to be slidable along the shaft; and
a cover support member which includes a main part configured to support the cover, a first connection part configured to connect the main part and the bush so as not to change relative position between the bush and the main part, and a second connection part configured to connect the main part and the bush in a manner that relative position between the bush and the main part is changeable.

2. The support structure according to claim 1, wherein the second connection part is configured to be deformable at least in the second direction.

3. The support structure according to claim 2, wherein the second connection part is a flat spring, and the flat spring has a cutout portion formed by cutting away a portion of the flat spring along a third direction extending from the bush to the main part.

4. The support structure according to claim 1, wherein at least one of the main part and the bush includes, formed therein, a recess portion which an end of a spring element of the second connection part enters, and the end is not in contact with a wall surface of the recess portion.
